(19) United States
(12) Patent Application Publication
(10) Pub. No.: US 2026/0184633 A1
(43) Pub. Date: Jul. 2, 2026

(54) SEALANT AND APPLICATIONS FOR SEALANTS

(71) Applicant: Ewald Dörken AG, Herdecke (DE)

(72) Inventors: Marcel Roth, Düsseldorf (DE); Daniel Miri, Wuppertal (DE); Jan Lischeid, Wetter (DE)

(73) Assignee: Ewald Dörken AG, Herdecke (DE)

(21) Appl. No.: 19/436,619

(22) Filed: Dec. 30, 2025

(30) Foreign Application Priority Data
Jan. 2, 2025 (EP) 25150041.9

(51) Int. Cl. C04B 14/06; C08K 3/26

(52) U.S. Cl. CPC C04B 14/06; C08K 3/26; C04B 2235/3215

(57) ABSTRACT

A sealant comprising an aluminum-containing filler and a binder, and uses thereof.

### CROSS REFERENCE TO RELATED APPLICATION

This application claims the benefit of European Patent Application No. EP 25150041.9, filed Jan. 2, 2025, which is incorporated herein by reference in its entirety.

### FIELD

The present invention relates to the technical field of sealants. In particular, the present invention relates to a sealant for sealing joints, in particular in masonry and in the sanitary sector.

### BACKGROUND

This section includes discussion intended to help understand various aspects of the subject matter presently disclosed below. This discussion should not be interpreted as constituting an admission of prior art.

Sealants are generally used for weatherstripping or sealing material transitions or component transitions with respect to liquid water and in particular for weatherstripping or sealing joints in regions with high moisture, for example in the outdoor sector or in the sanitary sector. The sealants protect the underlying construction against the penetration of water and the associated damage both by the moisture per se and by fungi, in particular mold fungi, which can also lead to health problems.

Furthermore, sealants are also used for permanently elastically joining building materials, in particular different building materials, and as compensating compounds for creating flat and attractive surfaces.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure generally relates to a sealant comprising an aluminum-containing filler and a binder.

In certain examples, the aluminum-containing filler is selected from the group of magnesium aluminum phosphates, magnesium aluminum silicates, calcium aluminum phosphates, calcium aluminum silicates, calcium aluminate hydrates, calcium aluminate sulfate and mixtures thereof.

In certain examples, the aluminum-containing filler is selected from the group of calcium aluminum phosphates, calcium aluminum silicates, calcium aluminate hydrates, calcium aluminate sulfate and mixtures thereof, in particular calcium aluminate hydrates, calcium aluminate sulfate and mixtures thereof.

In certain examples, the sealant comprises the aluminum-containing filler in amounts of 1 to 30% by weight, based on a solids content of the sealant.

In certain examples, the binder is selected from the group of silicones, polyurethanes, acrylates and mixtures thereof. In further examples, the sealant comprises the binder in amounts of 10 to 95% by weight, based on a solids content of the sealant.

In certain examples, the binder is selected from the group of silicones, acrylates and mixtures thereof.

In certain examples, the sealant further comprises an additive. In further examples, the additive is selected from the group of wetting agents, dispersants, catalysts, thickeners, pH regulators, plasticizers and mixtures thereof. In further examples, the sealant comprises the additive in amounts of 0.1 to 15% by weight, based on the sealant.

In certain examples, the sealant further comprises a further filler and/or at least one pigment.

In certain examples, the sealant comprises the further filler and/or the pigment in amounts of 1 to 70% by weight, based on the sealant. In further examples, the further filler is selected from the group of silica, quartz, talc, mica, chalk, calcium carbonate, barium sulfate, hollow microspheres and mixtures thereof.

In certain examples, the sealant is at least substantially free of preservatives.

In certain examples, the sealant has a Brookfield viscosity at 20° C. in a range from 10,000 to 100,000 mPas.

Certain examples relate to methods for using the sealant, including using the sealant to seal a joint in an outdoor or sanitary sector.

It should be recognized that the different aspects described throughout this disclosure may be combined in different manners, including those than expressly disclosed in the provided examples, while still constituting an invention accord to the present disclosure.

Various other features, objects and advantages of the disclosure will be made apparent from the following description taken together with the drawings.

### DETAILED DESCRIPTION

As discussed above, sealants have many uses with respect to weatherstripping, sealing, joining, and other important functions. Of particular importance are especially silicone-based sealants and acrylate-based sealants. Silicone and acrylic sealants can be used in numerous technical fields, including for sealing and joining. Their field of use extends from construction and construction projects to automotive and electronic applications. The extremely versatile materials offer excellent adhesion to various surfaces, are extremely flexible and resistant to weather influences.

Silicone sealants are used especially in construction and sanitary installations in order to seal joints. They are used, for example, between tiles, sinks and walls. Silicone sealants are the ideal choice for moist environments, such as bathrooms and kitchens, and in the electronics industry, in order to protect and insulate electrical components from moisture.

Since silicone sealants are often used in permanently moist regions, they are attacked by mold fungi and must have a high resistance to them. A decisive criterion in the selection of silicone sealants is therefore the ability to prevent mold formation, i.e. on the one hand to seal the joints and on the other hand not to be infested by mold.

Resistance to the formation of mold is achieved by the addition of biocides, chemical compounds which inhibit the growth of mold and other microorganisms. The biocides in silicone sealants reduce the nutrient content for mold and thus inhibit its multiplication. As a result, the sealed surfaces remain free of mold and unpleasant odors for longer.

In order to ensure the safety of man and the environment, it is essential that the biocides used are environmentally compatible and harmless to health. Silicone sealants with biocide equipment offer an extremely effective solution for preventing mold formation in various applications. The versatility, adhesion and protective properties of silicones make this material an indispensable constituent in regions in which tightness and hygiene are of decisive importance.

Mold formation in sealants occurs on account of the organic constituents of the materials. Both silicone sealants and acrylate-based sealants contain organic constituents which are an ideal nutrient medium for mold and other microorganisms, especially in a moist environment. Moisture and humidity in bathrooms, kitchens and other moist regions can lead to the organic components absorbing moisture and thus creating an optimal environment for the growth of mold. The organic constituents in the sealants can also be degraded by microorganisms, which leads to further promotion of mold growth. This degradation can lead to decomposition of the sealant and impair the integrity of the sealing, which ultimately leads to an increased risk of moisture ingress and damage to the sealed surfaces.

In particular, the following microorganisms can proliferate in sealants:
Mold fungi (Fungi):
   Aspergillus spp.
   Penicillium spp.
   Cladosporium spp.
   Alternaria spp.
Bacteria:
   Pseudomonas aeruginosa
   Staphylococcus aureus
   Escherichia coli
   Bacillus spp.
Yeasts (Fungi):
   Candida albicans
   Saccharomyces cerevisiae
   Cryptococcus spp.
   Rhodotorula spp.

These abovementioned species represent only some of the microorganisms occurring in or on sealants; they can occur in different combinations and concentrations in sealants, depending on the environmental conditions and the composition of the materials. The control of their growth is decisive in order to ensure the hygiene and longevity of the sealed surfaces.

In order to protect sealants against mold formation, biocides, in particular fungicides, are used as standard. The biocides or fungicides are added to the sealants as additives. Biocides or fungicides have the disadvantage that they are often relatively volatile compounds and escape from the sealants in the course of time, in particular are also released to the ambient air.

Biocides often have adverse health effects, are suspected of triggering allergies and also adversely influence useful microorganisms.

Silicone and acrylic sealants with biocide equipment are indeed extremely effective in preventing mold formation, but represent potential hazards to humans and the environment.

Silicone sealants with biocide equipment are, however, according to the prior art one of the best options for preventing mold formation.

Biocides are, as stated above, chemical compounds which inhibit the growth of microorganisms or kill microorganisms. Although they can effectively combat mold, they also entail risks. Biocides have health effects on humans, in particular in the case of prolonged or high-dose exposure. Skin irritations, allergies or even more serious health problems can be caused by some biocides. It is important to handle biocides appropriately in order to avoid accidental exposure, be it by skin contact, inhalation of vapors or swallowing.

Biocides have adverse effects on the environment and should therefore not be released. However, as a result of washing off treated surfaces, biocides pass, for example, into the wastewater and can have harmful effects on aquatic life forms in bodies of water. Certain biocides can accumulate in the environment and disrupt ecosystems. Silicone sealants with biocide equipment should therefore be used with caution.

The use of biocides comprises, inter alia:
Quaternary ammonium compounds:
   dodecylbenzyltrimethylammonium chloride (DABAC)
   benzalkonium chloride (BAC)
   cetyltrimethylammonium bromide (CTAB)
isothiazolinones:
   methylisothiazolinone (MIT)
   chloromethylisothiazolinone (CMIT)
   octylisothiazolinone (OIT)
phenols:
   p-chloro-m-cresol (PCMC)
   2,4,4′-trichloro-2′-hydroxydiphenyl ether (Triclosan)
Organic acids:
   propionic acid
   acetic acid
   benzoic acid
halogens:
   chlorine (in the form of sodium hypochlorite or dichlorodiphenyltrichloroethane)
   bromine

These biocides can be used individually or in combination in order to combat a broad spectrum of microorganisms and to control the growth of mold, bacteria and yeasts in sealants.

The abovementioned biocides all have the disadvantage that their use is problematic from the point of view of environmental and health protection and should, if possible, be avoided. Furthermore, the use of biocides is increasingly regulated and restricted to a greater extent by legislative measures.

Consequently, increased efforts are being made to find alternative solutions to sealants, especially silicone sealants, with biocide equipment, which represent less potential hazards to humans and the environment. However, these solutions must still have a mold-inhibiting action in order to ensure clean and hygienic surfaces.

However, the prior art still lacks a biocide-free or low-biocide sealant which has excellent resistance to colonization with mold fungi.

It is therefore an object of the present invention to avoid the abovementioned disadvantages associated with the prior art, but at least to mitigate them.

In particular, it is an object of the present invention to provide a biocide-free or low-biocide sealant which has a high resistance to mold fungi and other microorganisms and is outstandingly suitable for applications in the outdoor and sanitary sectors.

According to a first aspect of the present invention, the abovementioned object is solved according to the invention by a sealant comprising an aluminum-containing filler and a binder. Further advantageous embodiments according to the present disclosure are the subject matter of the subclaims in this respect.

Further subject matter of the present invention according to a second aspect of the present invention is the use of a sealant for sealing joints, including joints in outdoor or sanitary sectors.

It goes without saying that special features, features, arrangements and embodiments and also advantages or the like which are explained below only with respect to one aspect of the invention—for the purpose of avoiding unnecessary repetitions—of course apply correspondingly with respect to the other aspects of the invention, without this requiring explicit mention.

In addition, all values or parameter specifications or the like mentioned below can in principle be established or determined using normalized or standardized or explicitly specified determination methods or else determination methods which are familiar per se to the person skilled in the art in this field.

Furthermore, it also goes without saying that weight- or quantity-related percentage specifications are selected by the person skilled in the art in such a way that 100% result in total. Having said that, the present invention is described in more detail below.

The subject matter of the present invention-according to a first aspect of the present invention—is therefore a sealant, wherein the sealant comprises an aluminum-containing filler and a binder.

This is because, as the applicant has surprisingly found, mold-fungus-resistant or mold-inhibiting sealants or sealant materials can be obtained when an aluminum-containing filler is added to the sealant or the sealant material. Aluminum-containing fillers, in particular calcium—and aluminum-containing fillers, often have excellent biostatic, in particular fungistatic, properties, but do not represent conventional biocides, the use of which should be avoided. Instead, aluminum-containing fillers are harmless to health and environmentally compatible.

Aluminum-containing fillers, in particular calcium- and aluminum-containing fillers, can be added to sealants in large proportions without the processing properties or the product properties of the sealants being reduced or impaired.

Furthermore, in contrast to customary biocides or fungicides, aluminum-containing fillers are not extracted out of the sealants to a significant extent and are not volatile and consequently do not pass into the environment or even the ambient air. A particular advantage of the aluminum-containing fillers is that they can be used instead of customarily used fillers and pigments or can replace at least some of the customarily used pigments and fillers in sealants.

The sealant according to the invention is present in particular in highly viscous or pasty form. The sealants according to the invention may advantageously form permanently elastic materials after drying or curing.

In the context of the present invention, a sealant is to be understood as meaning in particular a material which is usually pasty and curing, for sealing joints, gaps, holes and the like, which can be subjected to movement. Sealants may be distinguished in particular in that they adhere to the joint flanks. Furthermore, however, sealants can also be used for the areal sealing of component surfaces.

In the context of the present invention, it is usually provided that the sealant is a reactive sealant. Reactive sealants are sealants whose chemical and/or physical properties change during the drying or curing process. By contrast, non-reactive sealants remain unchanged in their properties. Non-reactive sealants are, for example, oils and fats.

The sealant may advantageously be selected from the group of chemically reactive sealants and physically reactive sealants and mixtures thereof. In the context of the present invention, a chemically reactive sealant is to be understood as meaning a sealant which cures by chemical reaction, in particular crosslinking. A physically reactive sealant is to be understood as meaning in particular solvent-containing and/or aqueous binder systems which cure or dry by removal of the solvent or water.

The sealant according to the invention may advantageously be a sealant or a joint sealant.

In the context of the present invention, the aluminum-containing filler is usually selected from the group of magnesium aluminum phosphates, magnesium aluminum silicates, calcium aluminum phosphates, calcium aluminum silicates, calcium aluminate hydrates, calcium aluminate sulfate and mixtures thereof.

Particularly good results are obtained in the context of the present invention when the aluminum-containing filler is selected from calcium aluminate hydrates, calcium aluminate sulfate and mixtures thereof.

Particularly good results are obtained in this context when the aluminum-containing filler is selected from the group of tricalcium aluminate hydrate [3 CaO*Al2O3*6 H2O or Ca3 Al2(OH)12], tetracalcium aluminate hydrate [4 CaO*Al2O3*7 H2O or Ca4Al2(OH)14], calcium aluminate sulfate [ettringite, 3 CaO*Al2O3*3 CaSO4*32 H2O or Ca6 [Al(OH)6]2 (SO4) 2*26 H2O], and mixtures thereof. It is particularly advantageous when the aluminum-containing filler is selected from tetracalcium aluminate hydrate, calcium aluminate sulfate and mixtures thereof.

In the context of the present invention, it is particularly advantageous when the aluminum-containing filler is calcium aluminum sulfate [ettringite, 3 CaO*Al2O3*3 CaSO4*32 H2O or Ca6 [Al(OH)6]2 (SO4) 2*26 H2O]. The empirical formula is also occasionally specified with 24 molecules of crystal water, differing from the notation illustrated above with 26 molecules of crystal water. However, the same compound is always meant.

Calcium aluminate sulfate is sold commercially in the form of aqueous suspensions and as powder. Calcium aluminate sulfate is composed of the mineral ettringite and contains a calcium oxide content of approximately 13.5% by weight, an aluminum oxide content of approximately 8% by weight and a crystal water content of approximately 45% by weight. Calcium aluminate sulfate or ettringite or its aqueous dispersion is also used, inter alia, in isolated form as white pigment in building paints and in paper coating. Calcium aluminate sulfate has a high opacity and a strong settling and rapid drying behavior, so that it cannot usually be used in highly concentrated form and processing to give the coating compositions is already problematic. The use of calcium aluminate sulfate is therefore greatly limited despite its inhibiting action on microorganisms. Surprisingly, it has been shown that calcium aluminate sulfate in particular also exerts a reinforcing action on the sealant and protects it from mechanical damage. The reason for this action has not yet been clarified, but it is assumed that the needle-like formation of the particles is responsible for this.

It is usually provided in the context of the present invention that the aluminum-containing filler is present in particle form.

In general, the aluminum-containing filler has a particle size distribution D50 in the range from 0.5 to 120 μm, in particular 0.6 to 100 μm, 0.7 to 80 μm, or 0.8 to 70 μm.

In certain embodiments according to the present disclosure, the aluminum-containing filler has a particle size distribution D50 in the range from 10 to 120 μm, in particular 25 to 100 μm, 40 to 80 μm, 50 to 70 μm. This particle size distribution is particularly advantageous when the aluminum-containing filler is used as powder.

In the context of the present invention, it can be provided according to a further advantageous embodiment that the aluminum-containing filler has a particle size distribution D10 in the range from 0.05 to 0.5 μm, in particular 0.1 to 0.4 μm, 0.15 to 0.3 μm, or 0.18 to 0.25 μm.

Equally, it can be provided that the aluminum-containing filler has a particle size distribution D50 in the range from 1.0 to 4 μm, in particular 1.5 to 3.0 μm, 1.8 to 2.7 μm, or 2.0 to 2.5 μm.

Equally, it can be provided that the aluminum-containing filler has a particle size distribution D90 in the range from 5.0 to 10 μm, in particular 5.5 to 8.0 μm, 6.0 to 7.5 μm, or 6.5 to 7.0 μm.

These particle size distributions are particularly advantageous when the aluminum-containing filler is used in the form of a dispersion for producing the sealant according to the invention.

The terms D10, D50 and D90 are to be understood in each case as meaning that 10% of all particles have a smaller particle size or 50% of all particles or 90% of all particles. The particle sizes or the particle size distribution can be established in particular by means of laser scattering.

As far as the amount in which the sealant can contain the aluminum-containing filler is concerned, this can vary within wide ranges. It has proven to be expedient within the scope of the present invention when the sealant comprises the aluminum-containing filler in amounts of at most 30% by weight, in particular at most 20% by weight, at most 10% by weight, or at most 8% by weight, based on the solids content of the sealant.

Equally, it can be provided that the sealant comprises the aluminum-containing filler in amounts of at least 1% by weight, in particular at least 3% by weight, at least 5% by weight, or at least 6% by weight, based on the solids content of the sealant.

Furthermore, particularly good results are obtained when the sealant comprises the aluminum-containing filler in amounts of 1 to 30% by weight, in particular 3 to 20% by weight, 4 to 10% by weight, or 6 to 8% by weight, based on the solids content of the sealant.

The aluminum-containing filler can therefore be contained in the sealant in a high concentration and can also be used as sole pigment or sole filler.

As already stated above, the sealant comprises at least one binder. In the context of the present invention, it is ensured that the sealant comprises a binder selected from the group of silicones, polyurethanes, acrylates and mixtures thereof. The binder may be selected from the group of silicones, acrylates and mixtures thereof. The binder may be selected from the group of silicones and acrylates. The binders used in the context of the present invention therefore may be reactive binders. In the case of silicones, they are chemically reactive binder systems or sealants, while acrylates are physically reactive binder systems or substances. Polyurethanes can either be chemically reactive or physically reactive.

If the binder is a chemically reactive binder, it may be provided that the binder comprises at least one crosslinker and/or hardener. In particular, compounds from the group of alkoxysilanes, amino silanes, oxime silanes, vinyl silanes, peroxides, silicic acid esters and mixtures thereof are used as crosslinkers or hardeners. In this case, the binder is a multi-component, in particular two-component, system of one or more binder bases, in particular a binder base, and at least one crosslinker and/or hardener. However, the sealant according to the invention is advantageously a one-component system, even if a reactive binder is used.

In the context of the present invention, it is usually provided that the sealant comprises the binder in amounts of 10 to 95% by weight, in particular 12 to 80% by weight, or 15 to 60% by weight, based on the solids content of the sealant.

Equally, it is possible that the sealant comprises the binder in amounts of at least 10% by weight, in particular at least 12% by weight, or at least 15% by weight, based on the solids content of the sealant.

Furthermore, equally particularly good results are obtained when the sealant comprises the binder in amounts of at most 95% by weight, in particular at most 80% by weight, or at most 60% by weight, also based on the solids content of the sealant.

If the binder comprises a crosslinker and/or hardener, it has proven to be expedient when the binder comprises the crosslinker and/or hardener in amounts of 1 to 70% by weight, in particular 10 to 60% by weight, or 40 to 55% by weight, based on the binder.

In certain embodiments according to the present disclosure, the sealant comprises:
(a) at least one aluminum-containing filler, in particular in amounts of 1 to 30% by weight, and
(b) at least one binder, in particular in amounts of 10 to 98% by weight, in each case based on the solids content of the sealant.

All abovementioned parameters, features, advantages and special features apply correspondingly to this embodiment and others according to the present disclosure.

In the context of the present invention, it may also be provided that the sealant comprises at least one additive.

If the sealant comprises an additive, the additive is usually selected from the group of wetting agents, dispersants, catalysts, rheology regulators, thickeners, pH regulators, plasticizers and mixtures thereof.

In the case where the sealant comprises an additive, it has proven to be expedient when the sealant comprises the additive in amounts of 0.1 to 15% by weight, in particular 0.5 to 10% by weight, or 1 to 8% by weight, based on the solids content of the sealant.

In certain embodiments according to the present disclosure, the sealant comprises:
(a) at least one aluminum-containing filler, in particular in amounts of 1 to 30% by weight,
(b) at least one binder, in particular in amounts of 10 to 98% by weight, and
(c) at least one additive, in particular in amounts of 0.1 to 15% by weight, in each case based on the sealant.

All abovementioned parameters, features, advantages and special features apply correspondingly to this embodiment and others according to the present disclosure.

Furthermore, it is advantageously provided in the context of the present invention that the sealant comprises at least one further filler and/or at least one pigment. The properties of the sealant and its color can be set in a targeted manner by the further fillers or pigments.

If the sealant comprises a further filler and/or a pigment, it has proven to be expedient when the sealant comprises the further filler and/or the pigment in amounts of 1 to 70% by weight, in particular 5 to 60% by weight, or 5 to 50% by weight, based on the solids content of the sealant.

Equally, it can be provided in the context of the present invention that the sealant comprises the further filler and/or the pigment in amounts of at least 1% by weight, in particular at least 5% by weight, based on the solids content of the sealant.

Furthermore, it is possible that the sealant comprises the further filler and/or the pigment in amounts of at most 70% by weight, in particular at most 60% by weight, or at most 50% by weight, based on the solids content of the sealant.

If the sealant comprises at least one further filler and/or at least one pigment in addition to the aluminum-containing filler, it is usually provided that the sum of aluminum-containing filler and further filler or pigment is at most 80% by weight, in particular at most 70% by weight, at most 65% by weight, or at most 60% by weight, based on the solids content of the sealant.

Equally, it can be provided that the sum of aluminum-containing filler and further filler or pigment is at least 2% by weight, in particular at least 5% by weight, at least 8% by weight, or at least 10% by weight, based on the solids content of the sealant.

In certain embodiments according to the present disclosure, it is provided that the sealant comprises the aluminum-containing filler and the further filler or the pigment in a total amount of 2 to 80% by weight, in particular 5 to 70% by weight, 8 to 65% by weight, or 10 to 60% by weight, based on the solids content of the sealant.

As stated above, it may be provided that the sealant comprises a pigment.

The pigment is usually selected from the group of organic pigments, inorganic pigments and mixtures thereof.

In general, the pigment used in the context of the present invention is selected from the group of organic and/or inorganic pigments, in particular pigment blacks, metal oxides, in particular oxides of titanium, zinc, iron and/or cerium, and mixtures thereof.

Suitable organic pigments comprise, for example, nitroso, nitro, azo, xanthene, quinoline, anthraquinone, phthalocyanine, metal complex, isoindolinone, isoindoline, quinacridone, perinone, perylene, diketopyrrolopyrrole, thioindigo, dioxazine, triphenylmethane and quinophthalone compounds. Furthermore, the organic pigments may be selected, for example, from: carmine, carbon black, aniline black, azo yellow, quinacridone, phthalocyanine blue. Examples thereof are: PY 74, PY 65, PY 110, PR 112, PR 122, PR 254, PR 168, PO 5, PG 7, PB 15:1, PB 15:2, PB 15:3, PB 15:4 and PBk 7.

Suitable inorganic pigments comprise, for example, metal oxides or other metal compounds which are sparingly soluble or at least substantially insoluble in water, in particular oxides of titanium, for example titanium dioxide (CI 77891), zinc, iron, for example red and black iron oxide (Cl 77491 (red), 77499 (black)) or iron oxide hydrate (Cl 77492, yellow), zirconium, silicon, manganese, aluminum, cerium, chromium and mixed oxides of the stated elements and mixtures thereof. Further suitable pigments are barium sulfate, zinc sulfide, manganese violet, ultramarine blue and Prussian blue pigments. The pigments may be surface-modified, wherein the surfaces may comprise, for example, hydrophilic, amphiphilic or hydrophobic compounds or groups as a result of the modification. In particular, the inorganic pigments PR 101, PY 42, Pb 28, Pb 29, PW 6 and Pbk 33 may be used. The surface treatment may consist in providing the pigments with a thin hydrophilic and/or hydrophobic inorganic or organic layer by methods known to the person skilled in the art.

In the context of the present invention, it has proven to be expedient in particular when the pigment is selected from the group of titanium dioxide, iron oxide yellow, iron oxide red, bismuth vanadate, carbon black, toluidine red, phthalocyanine, phthalocyanine blue, monoazo yellow, isoindolinone yellow, quinacridone, benzimidazolone, diketopyrrolopyrrole red and mixtures thereof.

If the sealant comprises a further filler, it may be provided that the filler is selected from the group of silica, quartz, talc, mica, chalk, calcium carbonate, barium sulfate, hollow microspheres and mixtures thereof.

In certain embodiments according to the present disclosure, the sealant comprises
(a) at least one aluminum-containing filler, in particular in amounts of 1 to 30% by weight,
(b) at least one binder, in particular in amounts of 10 to 98% by weight,
(c) at least one additive, in particular in amounts of 0.1 to 15% by weight, and
(d) at least one further filler and/or at least one pigment, in particular in amounts of 1 to 70% by weight, in each case based on the solids content of the sealant,
with the proviso that the sealant comprises the aluminum-containing filler and the further filler or the pigment in a total amount of 2 to 80% by weight, based on the solids content of the sealant.

All abovementioned parameters, features, advantages and special features apply correspondingly to this embodiment and others according to the present disclosure.

Furthermore, it may be provided in the context of the present invention that the sealant comprises at least one dye.

If the sealant comprises a dye, the sealant usually comprises the dye in amounts of 0.1 to 15% by weight, in particular 1 to 10% by weight, or 2 to 8% by weight, based on the solids content of the sealant.

In certain embodiments according to the present disclosure, the sealant comprises:
(a) at least one aluminum-containing filler, in particular in amounts of 1 to 30% by weight,
(b) at least one binder, in particular in amounts of 10 to 98% by weight,
(c) at least one additive, in particular in amounts of 0.1 to 15% by weight,
(d) at least one further filler and/or at least one pigment, in particular in amounts of 1 to 70% by weight, and
(e) at least one dye, in particular in amounts of 0.1 to 15% by weight, in each case based on the sealant,
with the proviso that the sealant comprises the aluminum-containing filler and the further filler or the pigment in a total amount of 2 to 80% by weight, based on the solids content of the sealant.

In the context of the present invention, it is possible that the aluminum-containing filler has a non-negligible residual solubility.

In the context of the present invention, it can in particular be provided that the aluminum-containing filler has a solubility of less than 10 g/l, in particular less than 4 g/l, less than 3 g/l, less than 2 g/l, less than 1.5 g/l, or less than 1 g/l, at 20° C. in water.

In particular, it is possible that the aluminum-containing filler has a solubility of more than 0.1 g/l, in particular more than 0.2 g/l, more than 0.3 g/l, or more than 0.4 g/l, at 20° C. in water.

In the context of the present invention, it may be advantageous if the aluminum-containing filler has a solubility in the range from 0.05 to 10 g/1, 0.05 to 5 g/1, 0.1 to 4 g/1, 0.2 to 3 g/1, 0.2 to 2 g/1, 0.3 to 1.5 g/l, or 0.4 to 1 g/l, at 20° C. in water.

Compounds having the abovementioned relatively high solubilities, also referred to as residual solubilities, are in principle sparingly soluble and can be provided in the form of aqueous dispersions, for example acrylate-containing sealants, wherein use as powder is also possible. One advantage of the use of aluminum-containing solids is that any washed-out aluminum ions are regenerated by further dissolving of the aluminum-containing compounds and the biostatic or fungistatic action is maintained, wherein the aluminum-containing compounds are sparingly soluble such that no significant decrease in aluminum-containing compound is observed. Furthermore, it may be provided that the sealant comprises a solvent or water.

If the sealant comprises a solvent, the solvent is usually an organic solvent and is advantageously selected from the group of alcohols, ethers, carboxylic esters, ketones, amides and mixtures thereof.

In this context, it may be provided in particular that the solvent is selected from C1-to C6-alcohols, diethyl ether, glycol ethers, ethyl acetate, acetone, N,N-dimethylformamide and mixtures thereof.

Particularly good results are obtained in the context of the present invention when the solvent is selected from acetone, ethyl acetate, propylene glycol monomethyl ether, propylene glycol monoethyl ether, propylene glycol monobutyl ether, ethylene glycol monomethyl ether, ethylene glycol monoethyl ether, ethylene glycol monobutyl ether, ethanol, 1-propanol, 2-propanol, butanol and mixtures thereof. It is particularly advantageous when the solvent is selected from ethanol, 2-propanol and mixtures thereof. The best results are obtained in the context of the present invention when the organic solvent is ethanol.

In this context, it has proven to be expedient when the sealant comprises the solvent or water in amounts of up to 30% by weight, in particular up to 25% by weight, up to 22% by weight, or up to 20% by weight, based on the sealant.

Equally, it can be provided that the sealant comprises solvent or water in amounts of at least 5% by weight, in particular at least 8% by weight, or at least 10% by weight, based on the sealant.

Furthermore, it can also be provided in the context of the present invention that the sealant comprises water in amounts of 5 to 30% by weight, in particular 5 to 25% by weight, 8 to 22% by weight, or 10 to 20% by weight, based on the sealant.

In the context of the present invention, a sealant composition is to be understood as meaning the ready-to-use composition which, in addition to a later solids fraction, also comprises volatile constituents, such as, for example, solvent or water.

However, it is furthermore advantageously provided in the context of the present invention that the sealant is in particular at least substantially free of preservatives.

Furthermore, it is also advantageous that the sealant is in particular at least substantially free of biocides.

As already stated above, the sealant is usually present in pasty, highly viscous form. It is usually provided that the sealant has a Brookfield viscosity at 20° C. in the range from 10,000 to 100,000 mPas, in particular 10,000 to 50,000 mPas, or 15,000 to 30,000 mPas.

Further subject matter of the present invention-according to a second aspect of the present invention—is the use of an abovementioned sealant for sealing joints, in particular in the outdoor or sanitary sector.

For further details relating to this aspect of the invention, reference may be made to the above statements relating to the sealant according to the invention, which apply correspondingly with respect to the use according to the invention.

Non-limiting examples of embodiments according to the present disclosure are illustrated below.

### Sample Embodiments

### 1. Silicone Compositions

### 1.1 Preparation and Investigation of the Samples

In order to demonstrate the fungus-inhibiting resp. fungistatic action of the composition according to the invention, the base composition of a reactive two-component molded silicone is mixed with different proportions by weight of powdered calcium aluminate sulfate in a system for a comparative purpose. The calcium aluminate sulfate used has particle sizes D50=50 to 70μ m.

After uniform dispersion of the calcium aluminate sulfate particles in the silicone base composition, the silicone base composition is mixed with a hardener component in a weight-based ratio of 1:1. The weight-based proportion of the silicone base composition is calculated without the content of calcium aluminate sulfate. The amounts of calcium aluminate sulfate in the silicone base composition and in the resulting silicone mixture are specified in Tables 1 and 2.

TABLE 1
Amount of calcium aluminate sulfate in the silicone base composition

| ER240800 | Base |
|---|---|
| ER240800.1 | Base + 10% calcium aluminate sulfate |
| ER240800.2 | Base + 15% calcium aluminate sulfate |
| ER240800.3 | Base + 20% calcium aluminate sulfate |

TABLE 2
Amount of calcium aluminate sulfate in the reactive silicone mixture

| ER240800 | Standard |
|---|---|
| ER240800.1 | Standard + 5% calcium aluminate sulfate |
| ER240800.2 | Standard + 7.5% calcium aluminate sulfate |
| ER240800.3 | Standard + 10% calcium aluminate sulfate |

After mixing with the hardener component, the reactive silicone composition is cast to give test specimens of approximately 2 mm thickness. Samples of the test specimens are examined in more detail below for their resistance to fungal growth.

The samples are subjected to an evaluation of the action of microorganisms on plastics according to ISO 846:2019. The samples are examined by 2 different methods-method A and method B:

### Method A: Fungal Growth Test

The samples are inoculated with a spore suspension of different fungi. The fungi are capable of growing only with the aid of the sample material as carbon source. If the samples contain no usable nutrients, the fungi cannot develop mycelium and the plastic is not destroyed. Method A is suitable for evaluating the resistance of the sample to fungal attack if no further usable organic materials are present.

### Method B: Evaluation of the Fungistatic Action

The samples are placed on a complete nutrient medium with carbon source and inoculated with a spore suspension of different fungi. Even if the plastic contains no usable nutrients, the fungi can overgrow the sample and their metabolic products can attack the material. Any inhibition of fungal growth both on the plastic and also on the nutrient medium (inhibition zone) indicates a fungistatic activity of the plastic or the presence of an antifungal finish. Method B is intended to reflect the situation of surface contamination of the sample in practice, such as, for example, dirt, organic deposits, etc.

The samples are examined both according to method A and according to method B in each case after 28 days for any fungal growth. Furthermore, some of the samples are irrigated for two days in the presence of the spore suspension and then incubated for 28 days before examination for fungal growth is carried out. The results of the investigation are reproduced below.

### 1.2 Results

### Method A

The samples are both unirrigated and irrigated free of fungal growth.

### Method B

The sample “ER240800” shows both unirrigated and irrigated slight fungal growth. The samples “ER240800.1” and “ER240800.3” show slight fungal growth after 2 days of watering. The further sample variants are free of fouling.

The results of the individual samples are listed in Table 3 below, the following rating scale being used:

| Method | A/B |
|---|---|
| 0 | no growth discernible under microscopic observation |
| 1 | slight growth, no growth discernible with the naked eye, |
| | readily discernible under microscopic observation; |
| a | less than 25% of the sample surface area |
| b | less than 50% of the sample surface area |
| c | more than 50% of the sample surface area |
| 2 | slight growth, readily visible macroscopically, |
| | no more than 25% of the sample surface area. |
| 3 | medium growth, |
| | up to 50% of the sample surface area. |
| 4 | strong growth on more than 50% of the sample surface |

or If edge effects are discovered after the incubation, they are admittedly to be indicated, but are to be neglected in the assessment of the fungal growth as long as they are not wider than 5 mm on each side.

TABLE 3
Results of the evaluation according to ISO 846:2019

| sample | | fungal growth after 28 d | |
|---|---|---|---|
| designation | irrigation | Method A | Method B |
| 1. ER240800 | 0 d | 0 | 2 |
| | 2 d | 0 | 2 |
| 2. ER240800.1 | 0 d | 0 | 0 |
| | 2 d | 0 | 1a |
| 3. ER240800.2 | 0 d | 0 | 0 |
| | 2 d | 0 | 0 |
| 4.ER240800.3 | 0 d | 0 | 0 |
| | 2 d | 0 | 2 |

0 d = without irrigation
2 d = 2 days irrigated

### Silicone Sealant

A silicone sealant can be formulated especially according to the following composition:

TABLE 4
Composition of silicone sealant

| | Proportion |
|---|---|
| Component | [% by weight] |
| Vulcanized silicone rubber | 40-50 |
| Calcium aluminate sulfate | 2.5-20 |
| Methyltributylketoximsilane | 4-6 |
| Vinyltributylketoximsilane | 0.5-0.8 |
| Catalyst | 0.03-0.05 |
| Nano-(calcium carbonate) | 30-45 |
| Cerium-modified zinc-aluminum | 0.1-0.3 |
| alloy powder | |

The calcium aluminate sulfate used has particle sizes D50=50 to 70 μm.

### 3. Acrylate Sealant

An acrylate sealant can be formulated especially according to the following composition:

TABLE 5
Composition of acrylate sealant

| | Proportion |
|---|---|
| Component | [% by weight] |
| Aqueous acrylate dispersion | 25-40 |
| (50% solids fraction) | |
| Calcium aluminate sulfate dispersion | 5-30 |
| (63% solids fraction) | |
| Polysaccharide | 0.2-2 |
| Plasticizer | 4-10 |
| Fillers | 30-60 |
| Water | 4-6 |

The calcium aluminate sulfate used has particle sizes D10=0.2 μm, D50=0.9 μm and D90=3.0 μm.

This written description uses examples to disclose the invention, including the best mode, and also to enable any person skilled in the art to make and use the invention. Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A sealant comprising:
an aluminum-containing filler; and
a binder.

2. The sealant according to claim 1, wherein the aluminum-containing filler is selected from the group of magnesium aluminum phosphates, magnesium aluminum silicates, calcium aluminum phosphates, calcium aluminum silicates, calcium aluminate hydrates, calcium aluminate sulfate and mixtures thereof.

3. The sealant according to claim 1, wherein the aluminum-containing filler is selected from the group of calcium aluminum phosphates, calcium aluminum silicates, calcium aluminate hydrates, calcium aluminate sulfate and mixtures thereof, in particular calcium aluminate hydrates, calcium aluminate sulfate and mixtures thereof.

4. The sealant according to claim 1, wherein the sealant comprises the aluminum-containing filler in amounts of 1 to 30% by weight, based on a solids content of the sealant.

5. The sealant according to claim 1, wherein the binder is selected from the group of silicones, polyurethanes, acrylates and mixtures thereof.

6. The sealant according to claim 5, wherein the sealant comprises the binder in amounts of 10 to 95% by weight, based on a solids content of the sealant.

7. The sealant according to claim 1, wherein the binder is selected from the group of silicones, acrylates and mixtures thereof.

8. The sealant according to claim 1, further comprising an additive.

9. The sealant according to claim 8, wherein the additive is selected from the group of wetting agents, dispersants, catalysts, thickeners, pH regulators, plasticizers and mixtures thereof.

10. The sealant according to claim 8, wherein the sealant comprises the additive in amounts of 0.1 to 15% by weight, based on the sealant.

11. The sealant according to claim 1, further comprising a further filler and/or at least one pigment.

12. The sealant according to claim 11, wherein the sealant comprises the further filler and/or the pigment in amounts of 1 to 70% by weight, based on the sealant.

13. The sealant according to claim 11, wherein the further filler is selected from the group of silica, quartz, talc, mica, chalk, calcium carbonate, barium sulfate, hollow microspheres and mixtures thereof.

14. The sealant according to claim 1, wherein the sealant is at least substantially free of preservatives.

15. The sealant according to claim 1, wherein the sealant has a Brookfield viscosity at 20° C. in a range from 10,000 to 100,000 mPas.

16. A method for using the sealant according to claim 1, wherein the method includes using the sealant to seal a joint in an outdoor or sanitary sector.
